(19) United States
(12) Patent Application Publication
(10) Pub. No.: US 2006/0031718 A1
(43) Pub. Date: Feb. 9, 2006

(54) System and method for generating production-quality data to support software testing

(75) Inventors: Carey Thornhill, Hinesville, GA (US); Elaine Chapman, Columbus, GA (US)

Correspondence Address: James J. Mayberry, Esq.;KING & SPALDING LLP, 45th Floor, 191 Peachtree Street, N.E., Atlanta, GA, 30303, US

(73) Assignee: Total System Services, Inc., Columbus, GA (US)

(21) Appl. No.: 10/914,542

(22) Filed: Aug. 9, 2004

(51) Int. Cl. G06F 11/00

(52) U.S. Cl. 714/38

(57) ABSTRACT

Providing data as part of a testing regime for computer software. Random data values can be automatically generated to support the testing of any type of computer software that operates on data as part of its function. This random generation of data values can provide a breadth of data needed to fully stress the software program being tested. Data of any type can be provided to a testing regime and individual data elements may be related such that the provided data reflects realistic situations. Data can be extracted from data tables and/or generated through operating a function designed to generate a specific value type.

### FIELD OF THE INVENTION

The present invention relates to providing data to test computer software and specifically to a system and method for developing random data items to support valid, production-quality computer software testing.

### BACKGROUND OF THE INVENTION

One aspect of computer software development is to test the performance of the software under conditions that closely resemble the conditions under which the software will be used. A goal of typical software testing regimes is to stress the software, that is, to simulate the complete range of situations that the software was designed to handle. For data-intensive software applications, this goal requires that adequate data input files be created to support the software testing.

Typically, these data input files are manually created. Creating these data input files can consume approximately fifty percent of a given test cycle time period. These manually-created files may also not be sufficiently realistic to adequately test the software. Also problematic is that, in this creation cycle, humans have a tendency to pattern data unconsciously. Because of this pattern data, fewer software errors are uncovered, identified, and corrected. The lack of variety in the pattern data may limit the conditions under which the software is evaluated. By failing to adequately stress out the software, errors in final release versions of the software may go undetected, even when the software is in use. For example, a software program that processes credit card information may reject transactions as one of its functions. An error in the software may cause valid transactions to be rejected or invalid transactions to be approved, with the software operator unaware of this condition.

These shortcomings may be multiplied by using complete data records as the test data sources. In other words, a single data record may include discrete data elements, such as a name, an address, a phone number, and an account number. By using these discrete data elements as a single record, the total variety of data combinations is minimized, since a single name would always be associated with the same address, the same phone number, and the same account number.

One solution may be to use actual data that the software, once finalized and released, may ultimately operate on. However, in many cases, these data may not exist or be available to developers during testing. Additionally, these data may contain confidential information, such that the data must be modified before it can be used. These modified data may suffer from the same deficiencies as data developed manually.

What is needed is an automated solution that can produce large quantities of realistic, randomized data to perform positive and negative test scenarios in both regression and development software environments.

### SUMMARY OF THE INVENTION

The present invention provides a system and method that provides an automated solution that can produce large quantities of realistic, randomized data that can be used to test computer software programs.

In one aspect of the present invention, a method for producing data to support software testing is provided. This method includes the steps of receiving a request for a data item; randomly developing the data item in response to the request; and returning the developed data item to support software testing.

In another aspect of the present invention, a system for producing data to support software testing is provided. This system includes a data call module, operable to receive a request for a data item and to transmit the data item in response to the request; a procedure module logically coupled to the data call module and a database module, operable to generate a random number to identify the data item within a database; and the database module, logically coupled to the procedure module and operable to retrieve the data item from the database based on the generated random number.

In yet another aspect of the present invention, a method for supporting software testing is provided. The method includes the steps of generating a random value for a data item and providing the generated data item as an input to the software program. The data item reflects a realistic data value for a software program being tested.

The aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a diagram illustrating a representative operating environment for an exemplary embodiment of the present invention.

FIG. 2 is a block diagram depicting the primary functional components of an exemplary embodiment of the present invention.

FIG. 3 is a flow diagram presenting a process for providing data for a test module in accordance with an exemplary embodiment of the present invention.

FIG. 4 is a flow diagram presenting a process for initializing data tables in a database in accordance with an exemplary embodiment of the present invention.

FIG. 5 is a flow diagram presenting a process for generating or retrieving data for testing software in accordance with an exemplary embodiment of the present invention.

FIG. 6 is a flow diagram presenting a process for performing a function to generate data for testing software in accordance with an exemplary embodiment of the present invention.

FIG. 7 is a flow diagram presenting a process for generating a data record used in testing software in accordance with an exemplary embodiment of the present invention.

FIG. 8 is a representative data table structure in accordance with an exemplary embodiment of the present invention.

FIG. 9a is a representative temporary data record structure in accordance with an exemplary embodiment of the present invention.

FIG. 9b is an exemplary temporary data record table in accordance with an exemplary embodiment of the present invention.

### DETAILED DESCRIPTION OF THE EXEMPLARY EMBODIMENTS

Exemplary embodiments of the present invention provide a system and method that provides an automated solution that can produce large quantities of realistic, randomized data that can be used to test computer software programs.

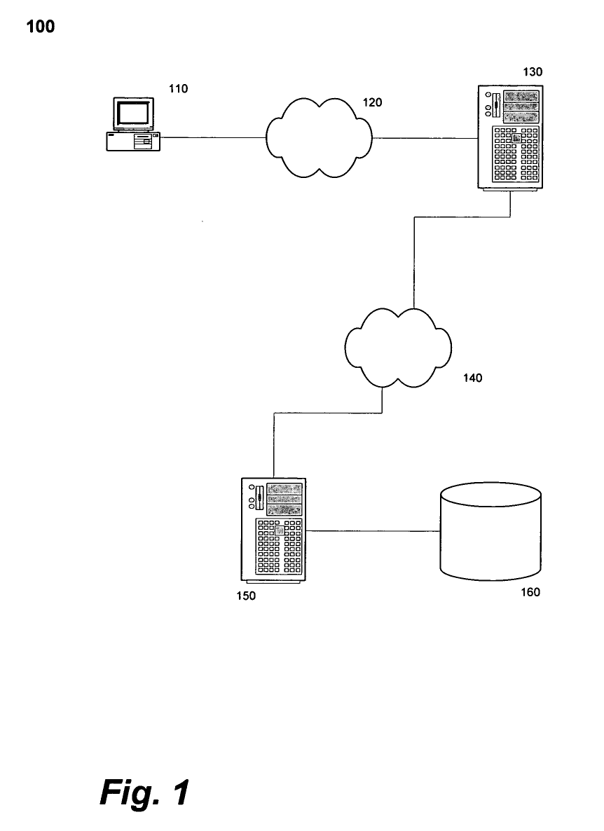

FIG. 1 is a diagram illustrating a representative operating environment 100 for an exemplary embodiment of the present invention. Referring to FIG. 1, client computer 110 is connected to a server computer 130 through a distributed computer network 120, such as a local area network (LAN) or wide area network (WAN), such as the internet. Computer software programs that are under development or testing may reside on the server computer 130, as well as a test module, that is, a specially-designed software program, that operates to conduct testing of the software under development. In this configuration, a user of the client computer 110 may access the server computer 130 to operate on the software contained on that server, including to further develop or test a software program resident on computer server 130.

The computer server 130 may be connected to a second computer server 150 through a distributed computer network 140. One skilled in the art would appreciate that the distributed computer network 140 may be the same network as the distributed computer network 120. The computer server 150 may contain software that develops data input that supports testing of software under development. The computer server 150 is connected to a database 160, which contains individualized data tables that support the data input development process. Under this configuration, software under development may be tested on the computer server 130 and data to support that testing may be developed on computer server 150.

One skilled in the art would appreciate that a variety of software and database configurations could be used to support software program testing. For example, the computer server 150 may include a Structured Query Language (SQL) database server software program that manages the data in the database 160 and provides the data as needed to support the testing of the software program under development and resident, for example, on the computer server 130.

Also, one skilled in the are would appreciate that the operating environment described in FIG. 1 is just one of many possible operating environments for the present invention. For example, in one alternative environment, a software program under development could reside directly on a client computer, such as client computer 110, and that client computer could have direct access to computer server 150 and database 160. In still another alternative environment, both the software under development and the software that provides data input in support of software testing may reside on the same server, such as computer server 150.

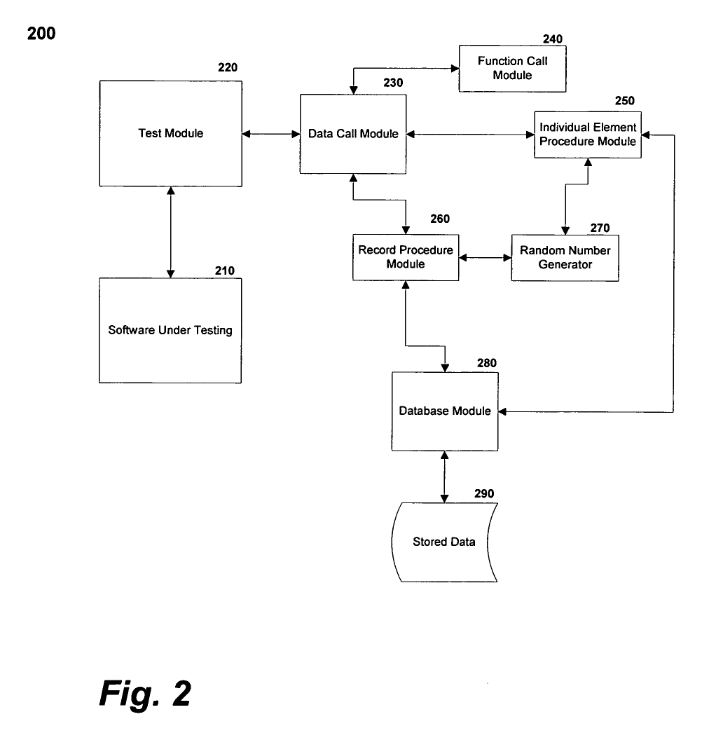

FIG. 2 is a block diagram 200 depicting the primary functional components of an exemplary embodiment of the present invention. Referring to FIG. 2, computer software 210 represents software undergoing development and testing. Test module 220 controls the testing of computer software 210. The test module 210 may be developed expressly to test the specific computer software 210.

The test module 220 can access a data call module 230. The data call module 230 is responsible for generating the data input used by the test module 220 to test the computer software 210. The data call module 220 can initiate a function call module 240. The function call module 240 generates data using a function, or algorithm. Specific functions may be used to generate specific data types. That is, one function may be used to generate one function type, such as a telephone number, while another function may generate a second data type, such as a social security number.

The data call module 220 can also initiate a individual element procedure module 250. The individual element procedure module 250 can randomly select data contained in individual element data tables. Similarly, the data call module 220 can also initiate a record procedure module 250. The record procedure module 250 can randomly select data contained in individual element data tables and develop a record that contains multiple individual data elements.

Both the individual element procedure module 250 and record procedure module 260 access a random number generator 270. The random number generator 270 provides random numbers used to select data from individual element data tables. Also, both the individual element procedure module 250 and record procedure module 260 access a database module 280. The database module 280 can retrieve data from a set of stored data 290, including individual data element tables.

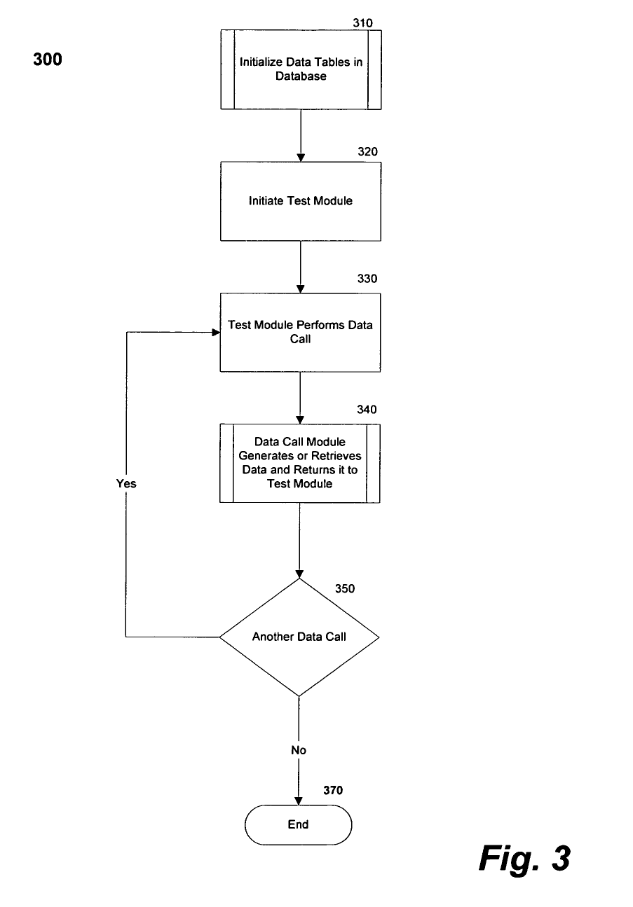

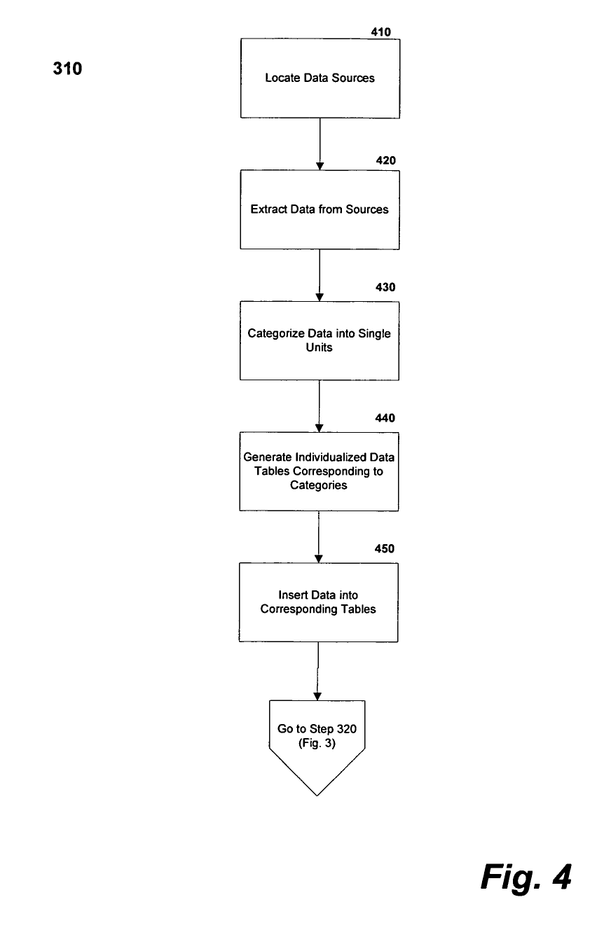

FIG. 3 is a flow diagram presenting a process 300 for providing data for a test module in accordance with an exemplary embodiment of the present invention. Referring to FIGS. 2 and 3, at step 310, data tables included in the stored data 290 are initialized. This step is discussed in greater detail below, in connection with FIG. 4.

At step 320, the test module 220 is initiated. This step may serve to start a process of testing computer software, such as computer software 210. At step 330, the test module 220 performs a data request, also referred to herein as a data call, to the data call module 230. The test module 220 may be established such that it makes multiple data calls throughout a testing process or may make a single data call to retrieve an entire set of data needed to conduct a test. In an alternative embodiment, the data request at step 330 may be generated by a software module other than a test module, such as a software module component of the software being tested.

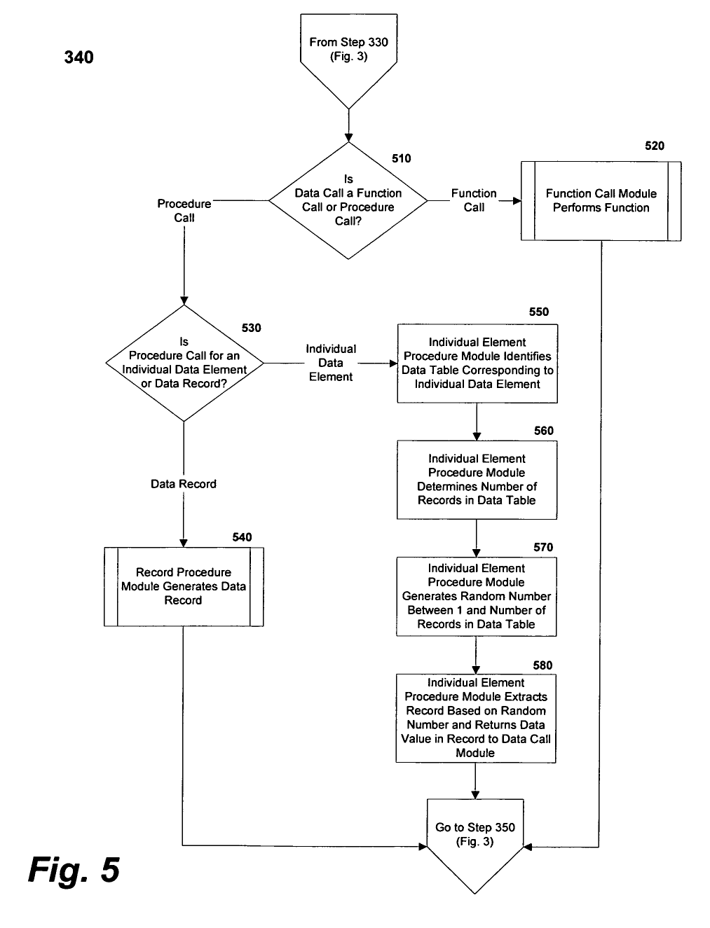

At step 340, the data call module 230 generates or retrieves data and returns the data to the test module 220. This step is discussed in greater detail below, in connection with FIG. 5. At step 350, the process 300 determines if another data call is needed. For example, the test routine being run by the test module 220 may call for data at different points throughout the testing process. If another data call is needed, then the process 300 returns to step 330. Otherwise, the process 300 ends at step 370.

FIG. 4 is a flow diagram presenting a process 310 for initializing data tables in a database in accordance with an exemplary embodiment of the present invention. Referring to FIGS. 3 and 4, at step 410, data sources are located. Data sources may include actual data of the types that will be used by the software once the software program is finalized or other sources of realistic data, such as data sources of addresses, phone numbers, personal identification numbers, or account numbers.

At step 420, data is extracted from the sources located at step 410. At step 430, the extracted data is categorized into single units, or data element groups. For example, all first names may be categorized in one group, last names in another group, and street names in still another group. Each group would encompass a single data element type.

In an embodiment, some related data elements may be group into a single element to provide more realistic data. For example, the postal zip code “30303” may be associated with the city “Atlanta” and the state “Georgia,” such that a single data element would be “Atlanta, Ga. 30303” within a city/state/zip code group. In an alternative embodiment, where more randomly generated data is desired, the data element “Atlanta” may be in the city group, the state “Georgia” may be in the state group and the postal zip code “30303” may be in the zip code group, without any relationship between the three data elements.

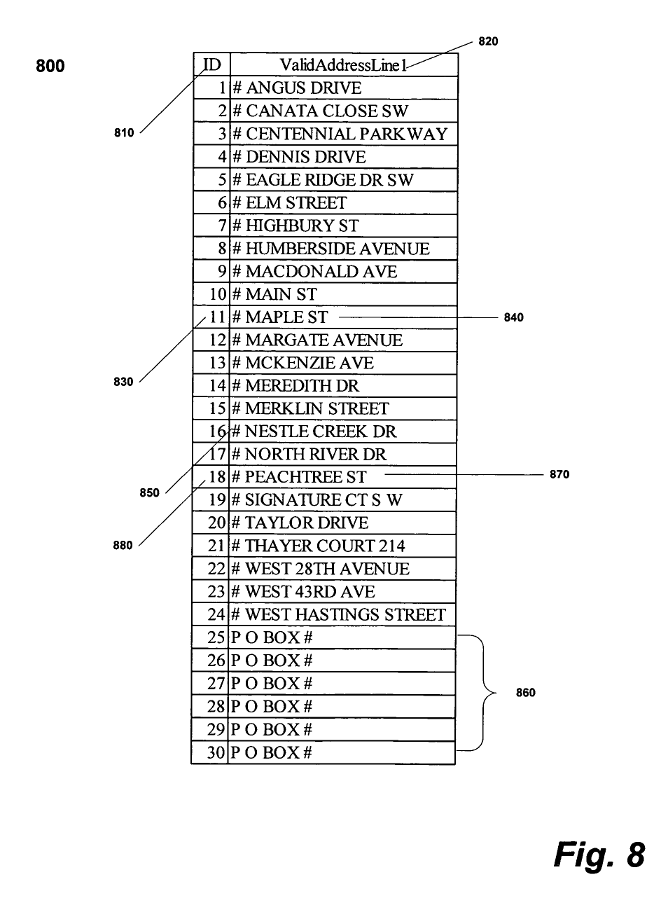

At step 440, individualized data tables are generated, with each data table corresponding to a single data element category. At step 450, the data extracted in step 420 and categorized in step 430 is inserted into the corresponding tables. An exemplary data element table is discussed below, in conjunction with FIG. 8. The process 310 then moves to step 320.

FIG. 5 is a flow diagram presenting a process 340 for generating or retrieving data for testing software in accordance with an exemplary embodiment of the present invention. Referring to FIGS. 2, 3, and 5, at step 510, the data call module 230 determines if a data call is a function call or a procedure call. A data request, or call, is a function call if the data element type involved in the data call is purely or primarily a number, such that a function can more efficiently randomly generate a data item value as compared to storing all possible data item values in a table. For example, the numerical component of a street address can be generated by a function. In this example, a function may be specified to provide a four digit numerical value that will represent the number component of a street address, such as “1234” in the street address “1234 Peachtree Street.” One skilled in the art would recognize that a function could be written to produce a great variety of numerical or alphanumerical values. The function can provide any number of characters, such as four characters for an address, nine characters for a social security number, or ten characters for a phone number. Also, the function may incorporate statistical or other rules to make the resulting values more realistic, such as a rule that ensures that the first and fourth characters of a phone number are non-zero.

A data call is a procedure call if data elements are to be extracted from data tables, such as the data tables initialized at step 310, either as a single element or to form a data record. These data elements may include first or last names, street names, and postal zip codes, either associated or not associated with city and state names.

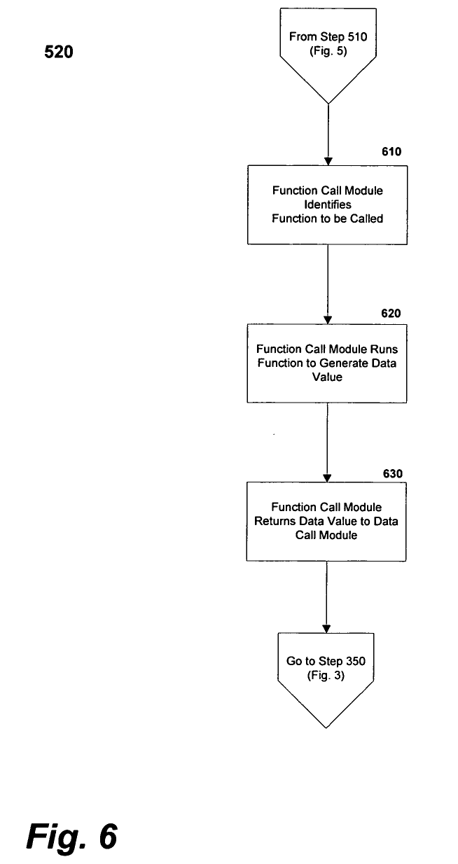

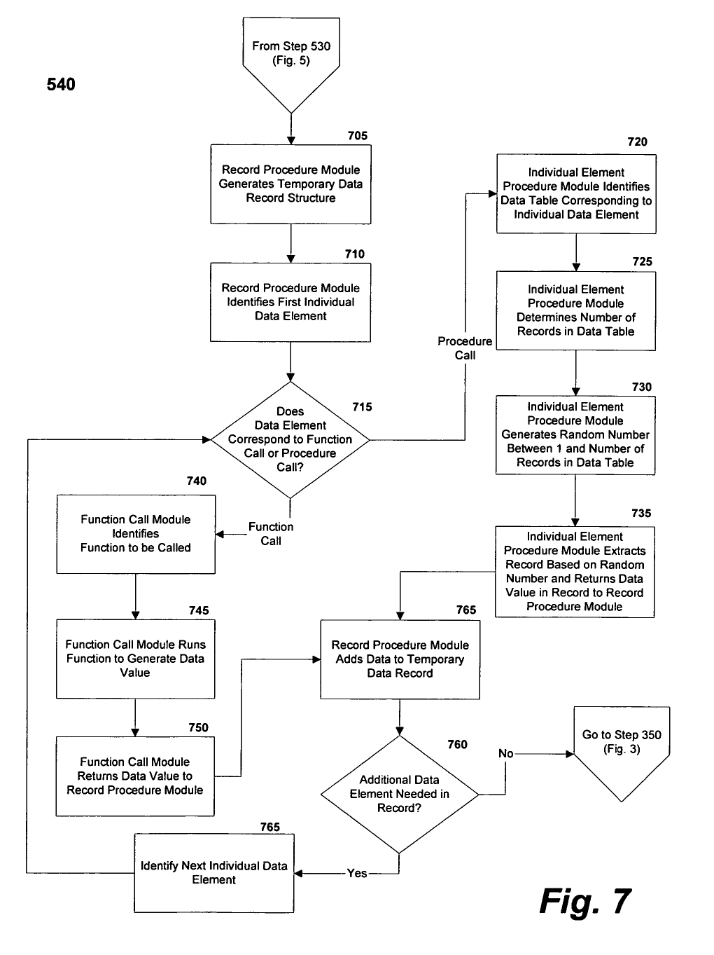

If the data call module 230 determines that the data call is a function call, the process 340 moves to step 520, where the corresponding function is performed by the function call module 240. This step is discussed in greater detail below, in connection with FIG. 6. If the data call module 230 determines that the data call is a procedure call, the process 340 moves to step 530. At step 530, the data call module determines if the procedure call is an individual data element call or a data record call. If the procedure call is a data record call, that is, the test module 220 desires a data record that contains multiple data elements, then the process 340 moves to step 540, where the record procedure module 260 generates a data record. Step 540 is discussed in greater detail below, in connection with FIG. 7.

If the procedure call is for an individual data element, then the process 340 moves to step 550. At step 550, the individual element procedure module 250 identifies the data table that corresponds to the individual data element associated with the data call. At step 560, the individual element procedure module 250 determines the total number of records in the identified data table. For example, the data call may be for a street name. In this example, at step 550, the individual element procedure module 250 would identify the data table that contains street names and, at step 560, the individual element procedure module 250 would determine how many records the street names data table contains. Generally, one record will contain one data element value. In our example, one street name, such as “Peachtree St” may serve as a single record and the total number of street names in the data table would be the total number of records in the data table.

At step 570, the individual element procedure module 250 generates a random whole number between 1 and the number of records in the data table, as determined at step 560. This step may be accomplished by the individual element procedure module 250 calling the random number generator 270. At step 580, the individual element procedure module 250 extracts the record from the data table corresponding to the random number generated at step 570 and returns that value to the data call module 230. The process 340 then moves to step 350 of process 300.

For example, the data table of interest may be a street name data table. That table may have thirty total records. A random whole number between 1 and 30 would be generated at step 570, such as the number “11.” The eleventh record may contain a street name “Maple St.” The value “Maple St” would be extracted from the data table and returned to the data call module 220 at step 580.

One skilled in the art would appreciate that in alternative embodiments, different approaches may be employed to randomly determine a record to be selected from the indicated data table. For example, an approach may identify the number of records in a data table, as in step 560, randomly identify any number less than the number of records value, then select either the number of records value or the randomly-generated value to indicate the record to extract at step 580. The identification and selection steps would ensure that there was an approximately equal chance of selecting any of the records in the record table.

FIG. 6 is a flow diagram presenting a process 520 for performing a function to generate data for testing software in accordance with an exemplary embodiment of the present invention. Referring to FIGS. 2, 3, 5, and 6, at step 610, the function call module 240 identifies the function to be called. At step 620, the function call module 240 runs the identified function to generate a data value. At step 630, the function call module 240 returns the generated data value to the data call module 230. The process 520 then moves to step 350 of process 300.

For example, the function call module 240 may identify the function to be called as the social security function. At step 620, the function is run and the value “133-65-3269” generated. At step 630, the value “133-65-3269” is returned to the data call module 230. In this example, the function may include algorithms to return a three-digit number, a two-digit number, and a four digit number, in that order, separated by a dash (“-”). Also, the function may include rules that impose specific requirements on the numbers, such as the first three-digit number may not have three zeros (“000”).

One skilled in the art would appreciate that one data element could actually consist of a composite of two or more individual data elements, where some of these elements are generated through a function call and others through a procedure call. For example, a street address data element can include a procedure call that extracts a street name and a function call that generates an address number.

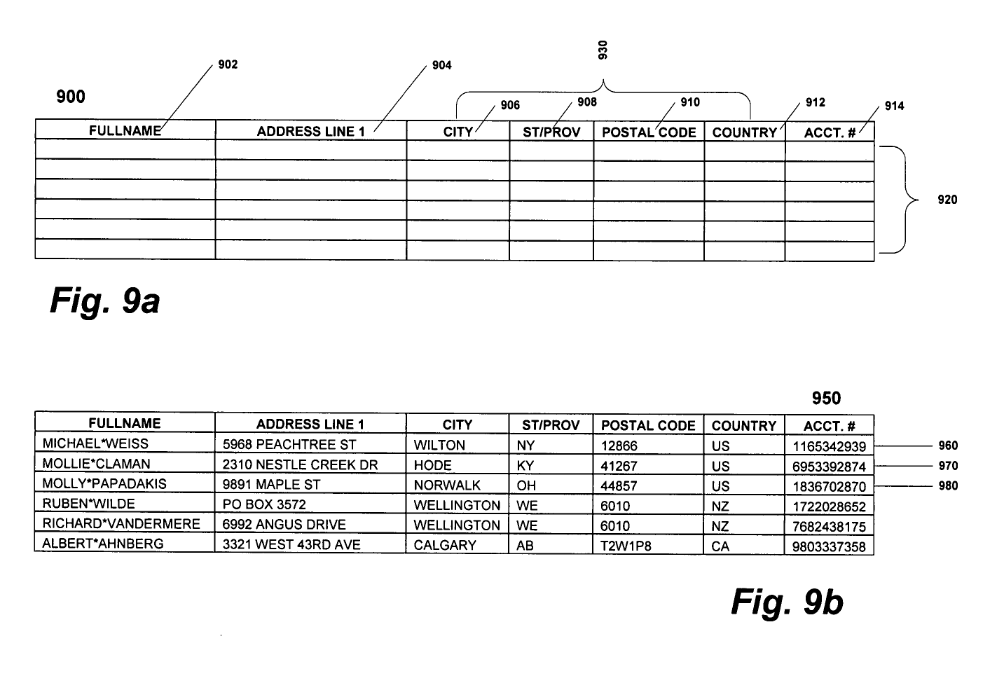

FIG. 7 is a flow diagram presenting a process 540 for generating a data record used in testing software in accordance with an exemplary embodiment of the present invention. Referring to FIGS. 2, 3, 5, and 7, at step 705, the record procedure module 260 generates a temporary data record. This data record would include placeholder data fields for each individual data element that forms a complete record. For example, the temporary data record may include first name, last name, street address, city/state/zip code, and account number data fields. FIGS. 9a and 9b, discussed below, present a representative temporary data record structure and completed temporary data record, respectively.

At step 710, the record procedure module 260 identifies an individual data element contained within the temporary data record structure generated at step 705. One skilled in the art would appreciate that this identification step could be done in a variety of ways, such as identifying the left-most individual data element in the record first and moving left to right to subsequent record elements or identifying data elements based on some hierarchy, such as those data elements generated by a function call first then those elements generated by a procedure call.

At step 715, the process 540 determines if the individual data element identified in step 710 corresponds to a function call or a procedure call. If the individual data element corresponds to a procedure call, then the process 540 moves to step 720. At step 720, the individual element procedure module 250 identifies the data table that corresponds to the individual data element associated with the data call. At step 725, the individual element procedure module 250 determines the total number of records in the identified data table.

At step 730, the individual element procedure module 250 generates a random whole number between 1 and the number of records in the data table, as determined at step 725. This step may be accomplished by the individual element procedure module 250 calling the random number generator 270. At step 735, the individual element procedure module 250 extracts the record from the data table corresponding to the random number generated at step 730 and returns that value to the record procedure module 260. This procedure call process is similar to the process described above, in connection with FIG. 5.

If, at step 715, the process 540 determines that the data element corresponds to a function call, the process 540 instead moves to step 740. At step 740, the function call module 240 identifies the function to be called. At step 745, the function call module 240 runs the identified function to generate a data value. At step 750, the function call module 240 returns the generated data value to the record procedure module 260. This function call process is similar to the process described above, in connection with FIG. 6.

At step 765, the record procedure module 260 receives the data, either from the individual element procedure module 250 or the function call module 240, and adds the data to the temporary record structure generated at step 705. At step 765, the process 540 determines if the temporary data record needs additional data elements, that is, has the temporary record structure been filled with the required data. If additional data elements are needed to complete the record, the process 540 follows the “Yes” path and moves to step 765, where the record procedure module 260 identifies the next individual data element to be placed into the temporary data record structure. If the data record is complete, the process 540 follows the “No” path and moves to step 350 in process 300.

FIG. 8 is a representative data table structure 800 in accordance with an exemplary embodiment of the present invention. Referring to FIGS. 2 and 8, the representative data table structure 800 includes two pieces of data for each record. These data include a record identifier 810, or ID, and a data element label 820, such as “ValidAddressLine1.” In this example, single record within the data table structure 800 would include an ID number and a first line of a valid address, such as the ID number 830, “11,” and the address line 840, “# Maple St.”

A number symbol in a record value, such as symbol 850, may indicate that a function call is needed in conjunction with the data in this table. In this example, a function call would supply the street address number, such as “1234” and a procedure call would supply the remaining portion of address line, such as “Maple St.” Similarly, the function call may supply a number after the procedure call portion of a data line, such as a P.O. Box number for the “PO Box” data records 860.

As can be seen from FIG. 8, a data table may contain duplicate instances of a data element value, such as the “PO Box” records 860. These duplicate occurrences may reflect real-world constraints on a data element type, for example that twenty percent of the addresses likely to be processed by the software being tested contain a post office box number. Alternatively, if this level of realism is not needed, the data table may not include any duplicate entries.

The exemplary data table structure 800 contains thirty (30) records. Applying this exemplary table to the procedure call processes described above, in connection with FIGS. 5 and 7, the individual element procedure module 250 would generate a random whole number, using the random number generator 270, between 1 and 30. The generated number would then be used to identify a data record. For example, if the randomly-generated number was “18,” the individual element procedure module 250 would return the value “Peachtree St,” 870, which is the value associated with record ID number “18” 880.

FIG. 9a is a representative temporary data record structure 900 in accordance with an exemplary embodiment of the present invention. Referring to FIG. 9a, the temporary data record structure 900 includes seven individual data elements: “FULL NAME” 902, “ADDRESS LINE 1” 904, “CITY” 906, “ST/PROV” 908, “POSTAL CODE” 910, “COUNTRY” 912, and “ACCT. #” 914. The temporary data structure 900 also includes placeholders for six complete data records 920, where a complete record includes a value for each of the seven individual data elements 902, 904, 906, 908, 910, 912, 914.

In some cases, the four data elements “CITY” 906, “ST/PROV” 908, “POSTAL CODE” 910, and “COUNTRY” 912 could be contained in a single data table and represent a single data element 930. One such case is where more data realism is needed in the software testing regime, such that the city, state, and country needs to correspond to a specific postal code. If this realism is not needed or desired, these four data elements could be treated as distinct, individual elements.

FIG. 9b is an exemplary temporary data record table 950, which includes six complete data records, in accordance with an exemplary embodiment of the present invention. Referring to FIGS. 8, 9a, and 9b, the temporary data record table 950 is a completed version of the temporary data record structure 900 and includes six complete records, such as record 960, which has a value for each of the seven individual data elements: “FULL NAME” 902, “ADDRESS LINE 1” 904, “CITY” 906, “ST/PROV” 908, “POSTAL CODE” 910, “COUNTRY” 912, and “ACCT. #” 914.

Record 960 includes, as part of the record, the values “Wilton, N.Y., US 12866.” This combination of four values reflects the real world. In other words, the city of Wilton is in the state of New York and has a postal code of 12866. Similarly, record 970 and 980 reflect real world values for the city, state, country, and postal codes. As discussed above in connection with FIG. 9a, this real-world connection between data is not necessary. Instead, the “CITY” 906, “ST/PROV” 908, “POSTAL CODE” 910, “COUNTRY” 912 data elements could have been chosen at random, such that one record could have had the value of “Wilton, Ky., CA 44857” if desired for testing. One reason to allow this departure from a realistic value is to test features of the software that may flag faulty data, such as a postal code from Canada that does not contain a letter. One skilled in the art would appreciate that any individual data element could be linked to any other individual data element to form a single data value as may be needed to properly test a given software program. Similarly, one skilled in the art would appreciate that the present invention can be used with any type of data processed by a computer program and is not limited to the personal identifying data used in the examples described herein.

The exemplary data record table 950 includes six complete records. One skilled in the art would recognize that an exemplary embodiment of the present invention could return single data records or a table with any number of data records as part of a record procedure, as described above in connection with FIG. 7.

In view of the foregoing, one would appreciate that the present invention supports a system and method for providing data as part of a testing regime for computer software. The system and method can automatically generate random data values to support the testing. This random generation of data values can provide a breadth of data needed to fully stress the software program being tested. The system and method have the flexibility to provide data of any type and data may be related such that the provided data reflects realistic situations. The system and method can provide data extracted from data tables and data generated through operating a function designed to generate a specific value type.

We claim:

1. A method for producing data to support software testing comprising the steps of:
receiving a request for a data item;
randomly developing the data item in response to the request; and
returning the developed data item to support software testing.

2. The method of claim 1 further comprising the step of initializing one or more data tables in a database prior to receiving the data item request from the test module.

3. The method of claim 2 wherein the step of initializing the one or more data tables in the database comprises the steps of:
extracting the data item from a data source;
categorizing the data item; and
generating a data table containing the data item, wherein the data table comprises one or more data items of the same category.

4. The method of claim 1 wherein the request for the data item comprises a request from a test module and wherein the step of returning the developed data item to support software testing further comprises the steps of:
returning the developed data item to the test module;
applying the data item to a software program under test; and
evaluating results achieved by applying the data item to the software program.

5. The method of claim 1, wherein the step of randomly developing the data item in response to the request comprises the steps of:
identifying a data table in a database that corresponds to the requested data item, wherein the data table comprises one or more data records;
determining the number of data records in the data table;
generating a random number, wherein the generated random number ranges from one to the determined number of data records in the data table; and
extracting the data record corresponding to the generated random number.

6. The method of claim 1, wherein the step of randomly developing the data item in response to the request comprises the steps of:
identifying a function to be operated to generate the data item; and
operating the identified function, wherein the operation randomly creates the data item.

7. The method of claim 1, wherein the step of randomly developing the data item in response to the request comprises generating a data record comprising at least two data items.

8. The method of claim 6, wherein the step of generating a data record comprising at least two data items comprises the steps of:
a) generating a temporary data record structure;
b) identifying a first data item to be included in the data record;
c) developing the first data item;
d) adding the first data item to the temporary data record structure; and
e) repeating steps b) through d) for a second data item.

9. The method of claim 7 wherein the step of developing the first data item comprises the steps of:
identifying a data table in a database that corresponds to the requested data item, wherein the data table comprises one or more data records;
determining the number of data records in the data table;
generating a random number in a range between one to the determined number of data records in the data table; and
extracting the data record corresponding to the generated random number.

10. The method of claim 7 wherein the step of developing the first data item comprises the steps of:
identifying a function to be operated to generate the data item; and
operating the identified function, wherein the operation randomly creates the data item.

11. A computer-readable storage device storing a set of computer-executable instructions implementing a method for producing data to support software testing comprising the steps of:
receiving a request for a data item;
randomly developing the data item in response to the request; and
returning the developed data item to support software testing.

12. The computer-readable storage device of claim 11 further comprising the step of initializing one or more data tables in a database prior to receiving the data item request from the test module.

13. The computer-readable storage device of claim 12 wherein the step of initializing the one or more data tables in the database comprises the steps of:
extracting a data item from a data source;
categorizing the data item; and
generating a data table containing the data item, wherein the data table comprises one or more data items of the same category.

14. The computer-readable storage device of claim 11 wherein the request for the data item comprises a request from a test module and wherein the step of returning the developed data item to support software testing further comprises the steps of:
returning the developed data item to the test module;
applying the data item to a software program under test; and
evaluating results achieved by applying the data item to the software program.

15. The computer-readable storage device of claim 11, wherein the step of randomly developing the data item in response to the request comprises the steps of:
identifying a data table in a database that corresponds to the requested data item, wherein the data table comprises one or more data records;
determining the number of data records in the data table;
generating a random number, wherein the generated random number ranges from one to the determined number of data records in the data table; and
extracting the data record corresponding to the generated random number.

16. The computer-readable storage device of claim 11, wherein the step of randomly developing the data item in response to the request comprises the steps of:
identifying a function to be operated to generate the data item; and
operating the identified function, wherein the operation randomly creates the data item.

17. The computer-readable storage device of claim 11, wherein the step of randomly developing the data item in response to the request comprises generating a data record comprising at least two data items.

18. The computer-readable storage device of claim 17, wherein the step of generating a data record comprising at least two data items comprises the steps of:
a) generating a temporary data record structure;
b) identifying a first data item to be included in the data record;
c) developing the first data item;
d) adding the first data item to the temporary data record structure; and
e) repeating steps b) through d) for a second data item.

19. The computer-readable storage device of claim 18 wherein the step of developing the first data item comprises the steps of:
identifying a data table in a database that corresponds to the requested data item, wherein the data table comprises one or more data records;
determining the number of data records in the data table;
generating a random number, wherein the generated random number ranges from one to the determined number of data records in the data table; and
extracting the data record corresponding to the generated random number.

20. The computer-readable storage device of claim 18 wherein the step of developing the first data item comprises the steps of:
identifying a function to be operated to generate the data item; and
operating the identified function, wherein the operation randomly creates the data item.

21. A system for producing data to support software testing comprising:
a data call module, operable to receive a request for a data item and to transmit the data item in response to the request;
a procedure module logically coupled to the data call module and a database module, operable to generate a random number to identify the data item within a database; and
the database module, logically coupled to the procedure module and operable to retrieve the data item from the database based on the generated random number.

22. The system of claim 21 further comprising a function call module, logically coupled to the data call module and operable to operate a function to randomly produce the data item.

23. The system of claim 21 wherein the procedure module comprises an individual element procedure module operable to randomly develop a single data item.

24. The system of claim 21 wherein the procedure module comprises a record procedure module operable to randomly develop a data record comprising at least two data items.

25. The system of claim 21 further comprising a random number generator, operable to generate the random number.

26. A method for supporting software testing comprising the steps of:
generating a random value for a data item, wherein the data item reflects a realistic data value for a software program under test; and
providing the generated data item as an input to the software program.

27. The method of claim 26 wherein the step of providing the generated data item as an input to the software program further comprises the steps of:
returning the generated data item to a test module;
applying the data item to a software program under test; and
evaluating results achieved by applying the data item to the software program.

28. The method of claim 26 wherein the step of generating the random value for the data item comprises using a function to generate the data item.

29. The method of claim 26 wherein the step of generating the random value for the data item comprises randomly selecting the data value from a data table comprising realistic data values.

30. The method of claim 29 wherein randomly selecting the data value from the data table comprises randomly selecting a record from the data table based on a randomly-generated number.
